(19) United States
(12) Patent Application Publication
(10) Pub. No.: US 2015/0157536 A1
(43) Pub. Date: Jun. 11, 2015

(54) DOSER HAVING TWO NEEDLES

(71) Applicants: Yu Qiu, Chongqing (CN); Ke Li, Chongqing (CN); Yuan Yuan, Chongqing (CN); Hongyu Li, Chongqing (CN)

(72) Inventors: Yu Qiu, Chongqing (CN); Ke Li, Chongqing (CN); Yuan Yuan, Chongqing (CN); Hongyu Li, Chongqing (CN)

(73) Assignee: CHONGQING LUMMY PHARMACEUTICAL CO., LTD., Chongqing (CN)

(21) Appl. No.: 14/415,604

(22) PCT Filed: Aug. 2, 2012
(86) PCT No.: PCT/CN2012/079549

§ 371 Date: Jan. 19, 2015

(30) Foreign Application Priority Data
Feb. 13, 2012 (CN) 201220045386.4
Apr. 23, 2012 (CN) 201220173732.7
Apr. 23, 2012 (CN) 201220173744.X

(51) Int. Cl. A61J 1/20; A61J 1/14

(52) U.S. Cl. CPC A61J 1/2089; A61J 1/1406; A61J 1/1475; A61J 2001/1481; A61J 2001/2013

(57) ABSTRACT

A doser having two needles. The two needles consist of a needle seat (1), an upper needle (2), and a lower needle (3). The upper needle (2) and the lower needle (3) are arranged at two sides of the needle seat (1), and the upper needle (2) and the lower needle (3) both have a hollow structure and are in communication with each other. A medicine mixing body (4) of a cup structure is formed through extension in the direction along the edge of the needle seat (1) toward the upper needle (2). When the doser having two needle is used, it is only required that the upper needle (1) penetrates through a sealing plug of a medicine container and the lower needle (3) simultaneously penetrates through a sealing plug inside a sealing cover on a transfusion container, and by squeezing the transfusion container, medicine in the medicine container can be mixed with a solution in the transfusion container, which makes the medicine mixing operation simpler and more time saving.

### TECHNICAL FIELD

The present utility model relates to a medical device, and particularly to a doser having two needles.

### BACKGROUND

For adding medicine in a medicine container (generally a penicillin bottle) to a solution in a transfusion container (a transfusion soft bag or a transfusion soft bottle), and then transfusing the mixed solution into a patient in a clinical institution such as a hospital.

In the prior art, an injector is usually used to mix medicine in a medicine container with the solution in a transfusion container (a transfusion soft bag or a transfusion soft bottle).First, an injector is used to inject the solution in the transfusion container (a transfusion soft bag or a transfusion soft bottle) into the medicine container, and then the same injector is used to inject the mixed solution into the transfusion container (a transfusion soft bag or a transfusion soft bottle). Currently, this kind of method is also commonly used in a clinical institution of a hospital. However, this medicine mixing method is complicated to operate and time-consuming, by which, not only medical dispensing error is susceptible to occur, but also contamination is likely to be introduced in the medicine mixing process, thereby impacting medication safety and causing a serious medical accident. Therefore, improving the medicine mixing method is an essential task for the preparation before transfusion.

### SUMMARY OF THE UTILITY MODEL

To eliminate the disadvantages described above in the prior art, a doser having two needles is provided according to the present utility model, which is only required to penetrate once to achieve medicine mixing and makes the medicine mixing operation simpler and more time-saving.

To address the technical problems mentioned above, the following technical solutions are employed in the present utility model:

A doser having two needles, wherein the two needles consist of a needle seat, an upper needle and a lower needle, the upper needle and the lower needle are arranged at both sides of the needle seat, the upper needle and the lower needle both have a hollow structure and are in communication with each other, wherein a medicine mixing body of a cup structure is formed through extending along an edge of the needle seat in a direction toward the upper needle.

As a preferred solution of the present utility model, the upper needle and the lower needle are both arranged along an axis of the medicine mixing body of the cup structure.

As another preferred solution of the present utility model, a sealing diaphragm is provided on an upper port of the medicine mixing body.

As yet another preferred solution of the present utility model, at least two anti-slip buckles in barb-shape and for preventing the medicine container from loosening are arranged symmetrically on the inner wall of the medicine mixing body.

As an improved solution of the present utility model, the two needles and the medicine mixing body are enclosed within an outer package.

As another improved solution of the present utility model, an annual rubber cushion sleeved outside the upper needle is provided at the bottom of the medicine mixing body.

As yet another improved solution of the present utility model, the doser having two needles further includes a sealing sleeve and a protecting sleeve, the sealing sleeve is sleeved onto a needle tip of the lower needle, the protecting sleeve is sleeved outside the sealing sleeve and fixed to the medicine mixing body or the lower needle.

As a further improved solution of the present utility model, the protecting sleeve is fixed to the bottom of the medicine mixing body.

As a further improved solution of the present utility model, a snapping sleeve is provided at the bottom of the medicine mixing body, the protecting sleeve is sleeved onto the snapping sleeve in a snapping manner and is hermetically cooperated with the snapping sleeve.

As a further improved solution of the present utility model, an annual boss is provided on an outer wall of the lower needle in a circumferential direction, the protecting sleeve is sleeved onto the annual boss and is hermetically cooperated with the annual boss.

As a further improved solution of the present utility model, the sealing sleeve is made of an elastic, flexible or soft material.

The advantageous effects of the present utility model include that, when the doser having two needles is used, it is only required to penetrate through the sealing plug of the medicine container by the upper needle, and to penetrate through the sealing plug in the sealing cover on the transfusion container (a transfusion soft bottle or a transfusion soft bag) simultaneously by the lower needle, and squeezing the transfusion container(a transfusion soft bag or a transfusion soft bottle), the medicine in the medicine container may be mixed with the solution in the transfusion container (a transfusion soft bag or a transfusion soft bottle), which makes the medicine mixing operation simpler and more time-saving.

DESCRIPTION OF THE DRAWINGS

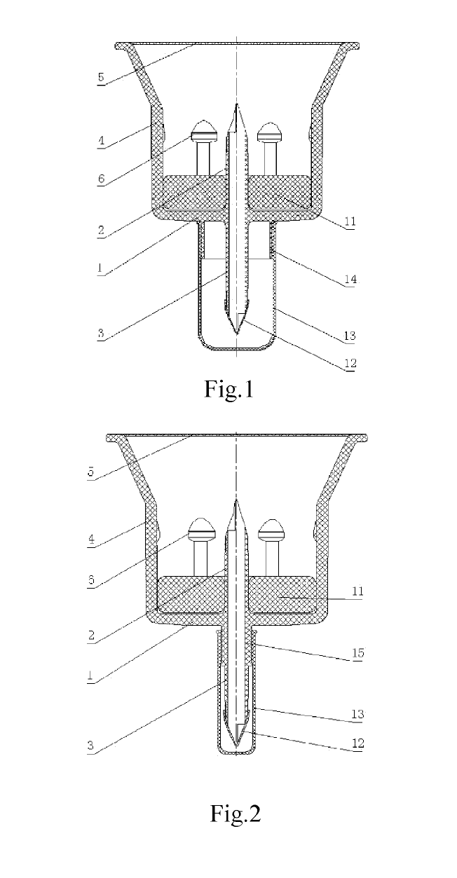

FIG. 1 is a sectional view of a doser having two needles according to example 1;

FIG. 2 is a sectional view of a doser having two needles according to example 2;

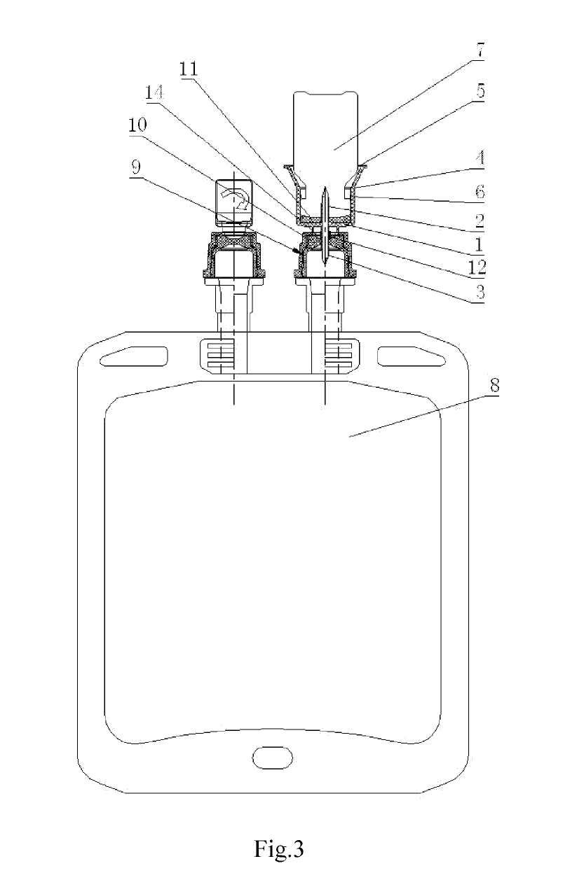

FIG. 3 is a schematic view showing the structure of the doser having two needles in a state that medicine is being mixed in the doser.

In the drawings:

1—needle seat; 2—upper needle; 3—lower needle; 4—medicine mixing body; 5—sealing diaphragm; 6—anti-slip buckle; 7—medicine container; 8—transfusion container; 9—sealing cover; 10—sealing plug; 11—annual rubber cushion; 12—sealing sleeve; 13—protecting sleeve; 14—snapping sleeve; 15—annual boss.

### DETAILED EMBODIMENTS

The present utility model is further described in detail hereinafter in connection with drawings and specific embodiments.

A doser having two needles is shown in FIG. 1, the two needles consist of a needle seat 1, an upper needle 2, and a lower needle 3. The upper needle 2 and the lower needle 3 are arranged at two sides of the needle seat 1, the upper needle 2 and the lower needle 3 both have a hollow structure and are in communication with each other. A medicine mixing body 4 of a cup structure is formed through extending along an edge of the needle seat 1 in a direction toward the upper needle 2. The upper needle 2 and the lower needle 3 are both arranged along an axis of the medicine mixing body 4 of the cup structure. In a case that a medicine container 7 is snapped into the medicine mixing body 4, the upper needle 2 is inserted into the medicine container 7 from the center of a sealing cover of the medicine container 7, to avoid that the upper needle 2 penetrates in an unexpected direction.

A sealing diaphragm 5 is provided on an upper port of the medicine mixing body 4, the two needles and the medicine mixing body 4 are enclosed within an outer package. Before use, the sealing diaphragm 5 is used with the outer package (eg. a sealing bag), such that the medicine mixing body 4 and the two needles can be in a sealing condition, which not only maintains that the medicine mixing body 4 and the upper needle 2 within the medicine mixing body 4 are of high level of cleanliness before use, but also effectively preserves the sharpness of the upper needle 2 and the internal structure of the medicine mixing body 4, thereby avoiding the damage during transportation. When in use, it is simply required to open the outer package and remove the sealing diaphragm 5.

At least two anti-slip buckles 6 in barb-shape and for preventing a penicillin bottle from loosening are arranged symmetrically on the inner wall of the medicine mixing body 4. In this example, six anti-slip buckles 6 are arranged symmetrically on the inner wall of the medicine mixing body 4. After the medicine container 7 is snapped into the medicine mixing body 4, under the hindering effect of the anti-slip buckles 6, the medicine container 7 may be prevented effectively from escaping or loosening from the medicine mixing body 4 in the opposite direction.

An annual rubber cushion 11 sleeved outside the upper needle 2 is provided at a bottom of the medicine mixing body 4. Since the annual rubber cushion 11 is of good elasticity, when the medicine container 7 is snapped into the medicine mixing body 4, the medicine container 7 may be prevented effectively from loosening by the annual rubber cushion 11 and the anti-slip buckles 6 at the medicine mixing body 4. The position at which the medicine container 7 is connected to the medicine mixing body 4 by being inserted is sealed completely by the annual rubber cushion 11, which prevents medicine leakage from occurring during medicine mixing, and strictly ensures the absolute air-tightness in the medicine container 4 after the medicine mixing, and avoids a risk of bacterial infections.

The doser having two needles further includes a sealing sleeve 12 and a protecting sleeve 13, the sealing sleeve 12 is sleeved onto the needle tip of the lower needle 3, and the protecting sleeve 13 is sleeved outside the sealing sleeve 12 and fixed to the medicine mixing body 4 or the lower needle 3. In FIG. 1, the protecting sleeve 13 is fixed to the bottom of the medicine mixing body 4. A snapping sleeve 14 is provided at the bottom of the medicine mixing body 4, the protecting sleeve 13 is sleeved onto the snapping sleeve 14 in a snapping manner and is hermetically cooperated with the snapping sleeve 14, simply sleeving the protecting sleeve 13 onto the snapping sleeve 14 is required when the sealing sleeve 12 is required to be protected; and simply removing the protecting sleeve 13 from the snapping sleeve 14 is required when the medicine is required to be mixed. The sealing sleeve 12 is made of an elastic, flexible or soft material, the sealing sleeve 12 is of elasticity or flexibility, and can contact closely with the outer wall of the lower needle 3 during the whole process of the medicine mixing without self-loosening and sliding. Of course, the protecting sleeve 13 may further be fixed to the lower needle 3 (as shown in FIG. 2), in such a case, an annual boss 15 is provided on the outer wall of the lower needle 3 in the circumferential direction, the protecting sleeve 13 is sleeved onto the annual boss 15 and is hermetically cooperated with the annual boss 15.

Since the sealing sleeve 12 is sleeved onto the needle tip of the lower needle 3, the needle tip of the lower needle 3 is allowed to be in a sealed condition by the sealing sleeve 12, and a passage within the two needles and the medicine mixing body 4 are allowed to be in a sealed condition by the sealing sleeve 12 and the sealing diaphragm 5 provided at the upper port of the medicine mixing body 4, thereby effectively preventing the passage within the two needles and the medicine mixing body 4 from being polluted. The protecting sleeve 13 is sleeved outside the sealing sleeve 12 and fixed to the medicine mixing body 4, the protecting sleeve 13 serves to keep the sealing sleeve 12 and the lower needle clean, thus it can prevent the sealing sleeve 12 from being removed from the needle tip under the action of an external force.

Using the doser having two needles may include, as shown in FIG. 3, after removing the sealing diaphragm 5 and the protecting sleeve 13, aligning the needle tip of the upper needle 2 with a sealing plug of the medicine container 7 directly, and meanwhile aligning the needle tip of the lower needle 3 with a sealing plug 10 in a sealing cover 9 on a transfusion container 8 (a transfusion soft bag is employed in the example), then quickly applying a force, to allow the needle tips to be pushed towards the sealing plugs. As the needle tip of the lower needle 3 penetrates downwardly, the sealing sleeve 12 is penetrated through and moved upwardly along the lower needle 3, which does not prevent the lower needle from penetrating downwards continually and is advantageous to a sterile connection between the medicine container 7 and the transfusion container 8. The doser having two needles may further be placed vertically, to allow the lower needle 3 to penetrate downwardly through the sealing plug 10 in the sealing cover 9 on the transfusion container 8 first, and then the upper needle 2 to penetrate through the sealing cover of the medicine container 7. The doser having two needles may further be inverted, to allow the upper needle 2 to penetrates downwardly through the sealing cover of the medicine container 7 first, and then the lower needle 3 to penetrate upwardly through the sealing plug 10 in the sealing cover 9 on the transfusion container 8. In each of the three means described above, the medicine container 7 and the transfusion container 8 can be connected by the doser having two needles. Finally, by squeezing the transfusion container, the medicine in the medicine container can be mixed with the solution in the transfusion container, which makes the medicine mixing operation simpler and more time-saving.

It is to be noted finally that. the above examples are only intended to illustrate technical solutions of the present utility model rather than a limitation to the present invention. Though the present utility model has been described in detail with reference to the preferred examples, it should be appreciated by an ordinary skilled in the art that, a few of modifications or equivalent substitutions may be made to the technical solutions of the present utility model without departing from the principle and scope of the technical solutions of the present utility model, and these modifications or equivalent substitutions should be encompassed in the scope defined by the claims of the present utility model.

1. A doser having two needles, wherein the two needles consist of a needle seat (1), an upper needle (2) and a lower needle (3), the upper needle (2) and the lower needle (3) are arranged at both sides of the needle seat (1), the upper needle (2) and the lower needle (3) both have a hollow structure and are in communication with each other, characterized in that a medicine mixing body (4) of a cup structure is formed through extending along an edge of the needle seat (1) in a direction toward the upper needle (2).

2. The doser having two needles according to claim 1, characterized in that the upper needle (2) and the lower needle (3) are both arranged along an axis of the medicine mixing body (4) of the cup structure.

3. The doser having two needles according to claim 1, characterized in that a sealing diaphragm (5) is provided on an upper port of the medicine mixing body (4).

4. The doser having two needles according to claim 1, characterized in that at least two anti-slip buckles (6) in barb-shape and for preventing a medicine container from loosening are arranged symmetrically on the inner wall of the medicine mixing body (4).

5. The doser having two needles according to claim 1, characterized in that the two needles and the medicine mixing body (4) are enclosed within an outer package.

6. The doser having two needles according to claim 1, characterized in that an annual rubber cushion (11) sleeved outside the upper needle (2) is provided at the bottom of the medicine mixing body (4).

7. The doser having two needles according to claim 2, characterized in that an annual rubber cushion (11) sleeved outside the upper needle (2) is provided at the bottom of the medicine mixing body (4).

8. The doser having two needles according to claim 3, characterized in that an annual rubber cushion (11) sleeved outside the upper needle (2) is provided at the bottom of the medicine mixing body (4).

9. The doser having two needles according to claim 4, characterized in that an annual rubber cushion (11) sleeved outside the upper needle (2) is provided at the bottom of the medicine mixing body (4).

10. The doser having two needles according to claim 5, characterized in that an annual rubber cushion (11) sleeved outside the upper needle (2) is provided at the bottom of the medicine mixing body (4).

11. The doser having two needles according to claim 1, characterized in that it further comprising a sealing sleeve (12) and a protecting sleeve (13), the sealing sleeve (12) is sleeved onto a needle tip of the lower needle (3), the protecting sleeve (13) is sleeved outside the sealing sleeve (12) and fixed to the medicine mixing body (4) or the lower needle (3).

12. The doser having two needles according to claim 2, characterized in that it further comprising a sealing sleeve (12) and a protecting sleeve (13), the sealing sleeve (12) is sleeved onto a needle tip of the lower needle (3), the protecting sleeve (13) is sleeved outside the sealing sleeve (12) and fixed to the medicine mixing body (4) or the lower needle (3).

13. The doser having two needles according to claim 3, characterized in that it further comprising a sealing sleeve (12) and a protecting sleeve (13), the sealing sleeve (12) is sleeved onto a needle tip of the lower needle (3), the protecting sleeve (13) is sleeved outside the sealing sleeve (12) and fixed to the medicine mixing body (4) or the lower needle (3).

14. The doser having two needles according to claim 4, characterized in that it further comprising a sealing sleeve (12) and a protecting sleeve (13), the sealing sleeve (12) is sleeved onto a needle tip of the lower needle (3), the protecting sleeve (13) is sleeved outside the sealing sleeve (12) and fixed to the medicine mixing body (4) or the lower needle (3).

15. The doser having two needles according to claim 5, characterized in that it further comprising a sealing sleeve (12) and a protecting sleeve (13), the sealing sleeve (12) is sleeved onto a needle tip of the lower needle (3), the protecting sleeve (13) is sleeved outside the sealing sleeve (12) and fixed to the medicine mixing body (4) or the lower needle (3).

16. The doser having two needles according to claim 11, characterized in that the protecting sleeve (13) is fixed to the bottom of the medicine mixing body (4).

17. The doser having two needles according to claim 16, characterized in that a snapping sleeve (14) is provided at the bottom of the medicine mixing body (4), the protecting sleeve (13) is sleeved onto the snapping sleeve (14) in a snapping manner and is hermetically cooperated with the snapping sleeve (14).

18. The doser having two needles according to claim 11, characterized in that an annual boss (15) is provided on the outer wall of the lower needle (3) in the circumferential direction, the protecting sleeve (13) is sleeved onto the annual boss (15) and is hermetically cooperated with the annual boss (15).

19. The doser having two needles according to claim 11, characterized in that the sealing sleeve (12) is made of an elastic, flexible or soft material.
